(19) United States
(12) Patent Application Publication
(10) Pub. No.: US 2018/0000173 A1
(43) Pub. Date: Jan. 4, 2018

(54) Mask With a Sound-transmitting Structure

(71) Applicants: GARRY TSAUR, Rowland Heights, CA (US); TING-HUA WANG, Taichung City (TW); FRANK TSAUR, Rowland Heights, CA (US); NANCY TSAUR, Taichung City (TW)

(72) Inventors: GARRY TSAUR, Rowland Heights, CA (US); TING-HUA WANG, Taichung City (TW); FRANK TSAUR, Rowland Heights, CA (US); NANCY TSAUR, Taichung City (TW)

(21) Appl. No.: 15/196,733

(22) Filed: Jun. 29, 2016

(51) Int. Cl. A41D 13/11; G10K 11/18

(52) U.S. Cl. CPC A41D 13/11; G10K 11/18

(57) ABSTRACT

A mask is provided with a sound-transmitting structure, which can transmit the spoken sound to the outside of the mask without removing the same. The mask comprises a mask body and a sound-transmitting structure, wherein the mask body is provided with the sound-transmitting hole, the sound-transmitting structure comprises the sound film and the sound inside the mask may be clearly transmitted to the outside of the mask through the sound-transmitting hole and the sound-transmitting structure.

### BACKGROUND OF THE INVENTION

### 1. Field of the Invention

The present invention relates to a mask provided with a sound transmitting structure, which may transmit the spoken sound to the outside of the mask without removing the same.

### 2. Description of the Prior Art

There are many reasons for wearing a mask. The mask may prevent foreign materials from entering the human body via the mouth and nose and protect the human body from the harm caused by air pollutions, germs and allergens.

In resent years, due to the mutation of influenza viruses, the immunity of the public to influenza viruses has decreased. If people with weak immunity suffer from flu, it may result in serious illness and even death. Wearing a mask may hinder external and internal spraying spittle, thereby reducing the transmission of diseases such as flu. Therefore, it is one of the methods for protecting oneself from being infected by diseases when taking the public transportation or going to crowded places such as a hospital. In a hospital, in order to avoid the cross infection, it is imperative for doctors, nurses, patients, and family members of patients to wear a mask for protecting themselves as well as others.

With the industrial progress, industrial activities such as motor vehicles burning fossil fuels and power plants generating electricity all will produce particulate matters such as aerosol particles, atmospheric particulate matters, aerosols, and hazes, making the air pollution problem increasingly serious. These particulate matters may be inhaled into the respiratory system, the blood system and even the nervous system and are considered to be associated with diseases such as asthma and lung cancer, influencing physical health greatly. To avoid inhaling noxious gases, hazes or other hazardous matters. It is necessary for motorcyclists, pedestrians and traffic polices to wear a mask. Wearing a mask may filtrate particulate matters such as aerosol particles and prevent the same from entering the human body.

The pollinosis is an anaphylaxis caused by pollen as the allergen, which mainly brings out the anaphylaxis of eyes, nose, respiratory tract, digestive tract, skin, and the like. People suffering from serious allergic asthma may even die from suffocation. In pollen season, most people with the allergic constitution will protect themselves by wearing a mask.

Now, it is the times of cellphone popularization. Almost every people has one for work as well as the interactions with family members and friends, and may use the cellphone for communication whenever and wherever possible. However, it is not uncommon that one needs to use the cellphone while in an environment that needs to wear a mask.

The basic function of the mask is stopping the air pollutants, PM 2.5, pollen, dusts and the like in the environment outside the mask while allowing the air to enter the mask for the breath of the user. In order to realize such a function, the mask needs a stratified structure for enabling stopping foreign materials, each stratified structure provided with a plurality of small holes for enabling the inflow and outflow of the air. The mask may filtrate aerosol particles, germs, viruses and pollen as a protective screen for the human body, but the multilayer and porosity of the structural feature of the mask may absorb partial sound frequency like the sound-absorbing cotton. Therefore, when one speaks, answers a phone especially, with a mask, there are only two situations: (1) Removing the mask for talking on the phone but giving up the protective function of the mask; (2) talking on the phone with the mask but partial sound frequency is absorbed by the mask so that the sound can not be clearly and completely transmitted to the phone, making the talk content heard by the other people unclearly.

The inventor has suffered from this contradiction for a long time. Therefore, an important topic that the present invention wants to solve herein is how to design a mask which may clearly transmit the spoken sound without influencing the protective function thereof such that in the case of wearing a mask, the wearer may make himself heard clearly while doing the action of talking on a phone.

### SUMMARY OF THE INVENTION

The present invention is designed to provide a mask with a sound-transmitting structure. The mask comprises a mask body and a sound-transmitting structure, wherein the mask body is provided with the sound-transmitting hole, the sound-transmitting structure comprises the sound film and the sound inside the mask may be clearly transmitted to the outside of the mask through the sound-transmitting hole and the sound-transmitting structure.

To realize the above-mentioned object of the present invention, the mask body is a single-layer or multi-layers structure.

To realize the above-mentioned object of the present invention, the sound-transmitting structure may be disposed outside the mask body, inside the mask body or between the inner layer and the outer layer of the mask body.

To realize the above-mentioned object of the present invention, the number of the sound-transmitting structure is one or more.

To realize the above-mentioned object of the present invention, the sound-transmitting structure may be fixed on the mask body by sealing.

To realize the above-mentioned object of the present invention, the sound-transmitting structure may be stuck to the mask body by gum.

To realize the above-mentioned object of the present invention, the sound-transmitting structure may be clamped to the mask body by a bracket.

To realize the above-mentioned object of the present invention, the materials of the sound film comprises paper, tiffany, silk, aluminum, titanium, polyethylene terephthalate (PET), polyethylene naphthalene (PEN), polyetherimide (PEI), polyurethane (PU), polyaryletherketone (PEEK), thermoplastic polyurethanes (TPU), and the high polymer material.

To realize the above-mentioned object of the present invention, the number of the sound-transmitting hole is one or more.

To realize the above-mentioned object of the present invention, the mask comprises the lint face mask, the N95 mask, the surgical mask, the activated carbon mask, and the paper mask.

### BRIEF DESCRIPTION OF THE DRAWINGS

FIG. 1 is a schematic diagram of the present invention, illustrating a mask with the sound-transmitting structure, wherein the sound-transmitting structure is sealed to the mask by ultrasonic wave.

FIG. 2 is a schematic diagram of the present invention, illustrating a mask with the sound-transmitting structure, wherein the sound-transmitting structure is stuck to the mask by the gum.

FIG. 3 is a schematic diagram of the present invention, wherein the sound-transmitting structure is clamped to the mask by a bracket.

FIG. 4 is a schematic diagram of the present invention, illustrating a surgical mask with the sound-transmitting structure, wherein the sound-transmitting structure is disposed within the three-layer structure of the surgical mask.

FIG. 5 is a schematic diagram of the present invention, illustrating a N95 mask with the sound-transmitting structure, wherein the number of the sound-transmitting structure is one or more.

FIG. 6 is a schematic diagram of the application of the present invention,

FIG. 7 is a schematic diagram of the present invention, illustrating a mask with the sound-transmitting structure, wherein the sound-transmitting structure is not positioned at the center of the mask.

### DETAILED DESCRIPTION OF THE PREFERRED EMBODIMENT

The present invention is exemplarily illustrated by but not limited to following embodiments.

### Embodiment One

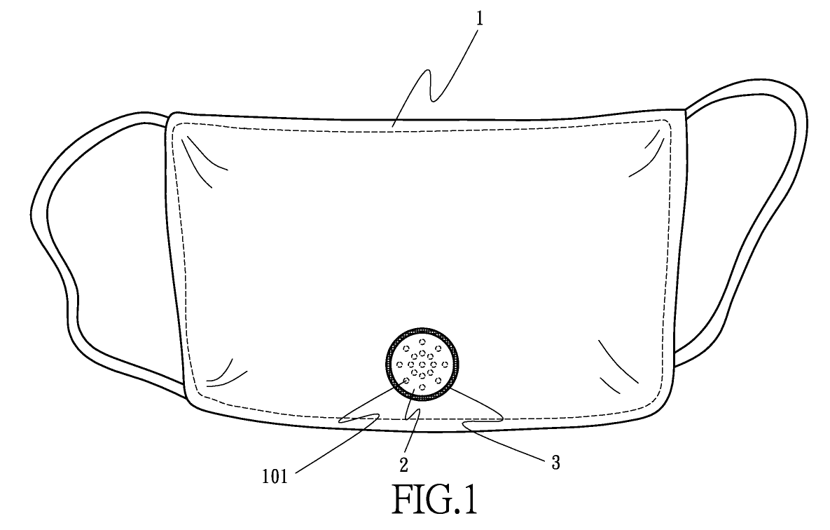

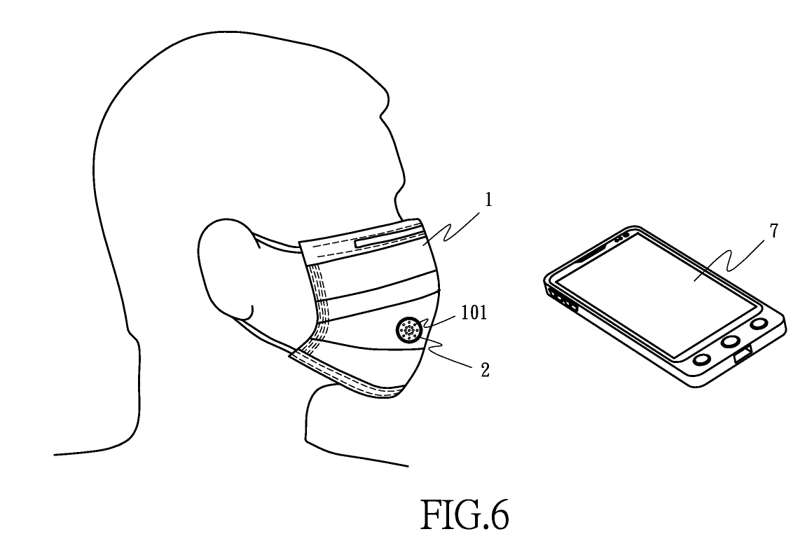

With reference to FIG. 1, the present invention is a mask provided with a sound-transmitting structure and the mask comprises a mask body 1. The sound-transmitting structure 2 is sealed to the outside of the mask body 1 by ultrasonic wave. One or a plurality of holes 101 are provided at the sealing area of the mask body 1 and the sound-transmitting structure 2 for the transmission of the sound. The sound-transmitting structure 2 comprises the sound film, wherein the sound film, also known as the vibrating diaphragm, is made from ventilate materials and will vibrate with the air vibration caused by the sound, thereby transmitting the sound to the other side of the sound film. As the mask is provided with the sound-structure which comprises the sound film, when one speaks, the sound inside the mask may be completely transmitted to the mouthpiece of the phone, the microphone and the like outside the mask, as shown in FIG. 6. The materials of the sound film are paper, tiffany, silk, aluminum, titanium, polyethylene terephthalate (PET), polyethylene naphthalene (PEN), polyetherimide (PEI), polyurethane (PU), polyaryletherketone (PEEK), thermoplastic polyurethanes (TPU), the high polymer material or other matters that may transmit the air vibration.

### Embodiment Two

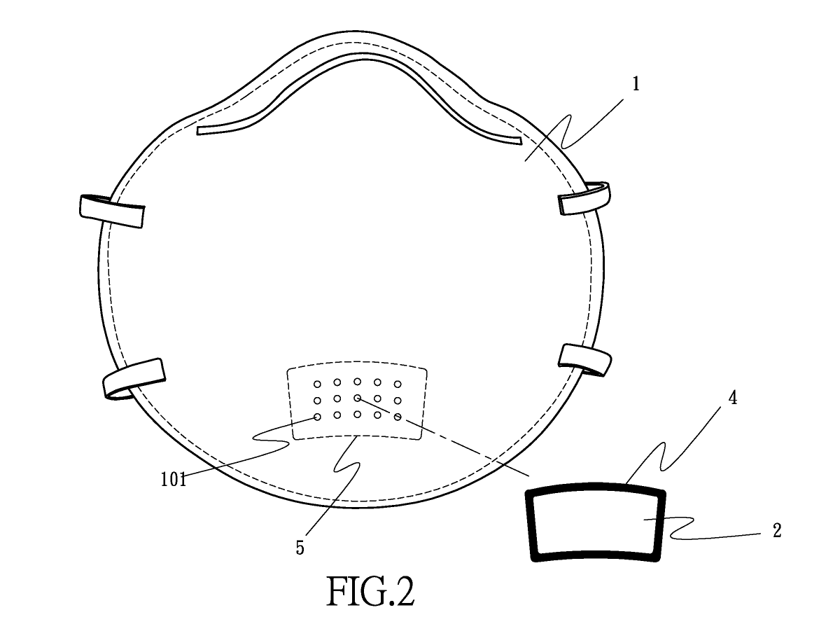

With reference to FIG. 2, The mask comprises a mask body 1. The sound-transmitting structure 2 is stuck and secured to the inside of the mask body 1 by gum. One or a plurality of holes 101 are provided at the bonding area of the mask body 1 and the sound-transmitting structure 2 for the transmission of the sound. The sound-transmitting structure 2 comprises the sound film, wherein the sound film, also known as the vibrating diaphragm, is made from ventilate materials and will vibrate with the air vibration caused by the sound, thereby transmitting the sound to the other side of the sound film. As the mask is provided with the sound-structure which comprises the sound film, when one speaks, the sound inside the mask may be completely transmitted to the mouthpiece of the phone, the microphone and the like outside the mask, as shown in FIG. 6. The materials of the sound film are paper,tiffany, silk, aluminum, titanium, polyethylene terephthalate (PET), polyethylene naphthalene (PEN), polyetherimide (PEI), polyurethane (PU), polyaryletherketone (PEEK), thermoplastic polyurethanes (TPU), the high polymer material or other matters that may transmit the air vibration.

### Embodiment Three

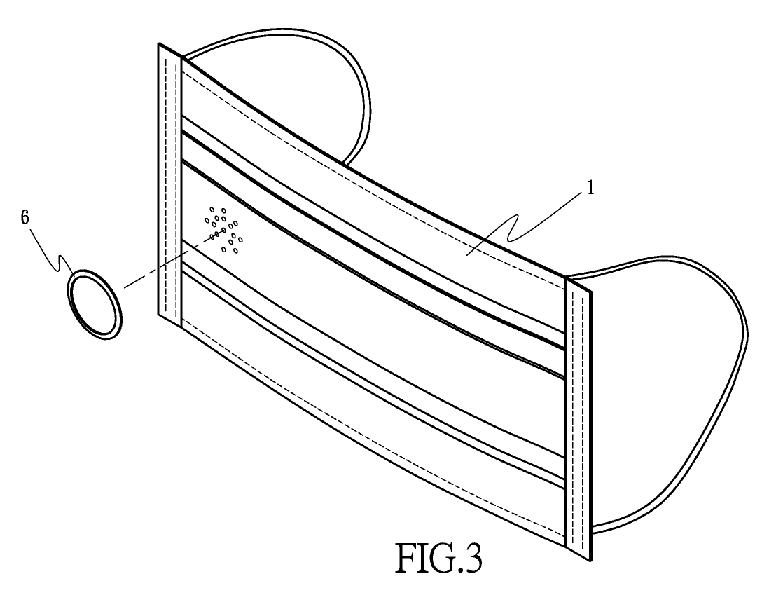

With reference to FIG. 3, The mask comprises a mask body 1. The sound-transmitting structure 2 is clamped to the mask body 1 by an inner and external bracket 6. One or a plurality of holes 101 are provided at the clamping area of the mask body 1 and the sound-transmitting structure 2 for the transmission of the sound. The sound-transmitting structure 2 comprises the sound film, wherein the sound film, also known as the vibrating diaphragm, is made from ventilate materials and will vibrate with the air vibration caused by the sound, thereby transmitting the sound to the other side of the sound film. As the mask is provided with the sound-structure which comprises the sound film, when one speaks, the sound inside the mask may be completely transmitted to the mouthpiece of the phone, the microphone and the like outside the mask, as shown in FIG. 6. The materials of the sound film are paper,tiffany, silk, aluminum, titanium, polyethylene terephthalate (PET), polyethylene naphthalene (PEN), polyetherimide (PEI), polyurethane (PU), polyaryletherketone (PEEK), thermoplastic polyurethanes (TPU), the high polymer material or other matters that may transmit the air vibration.

### Embodiment Four

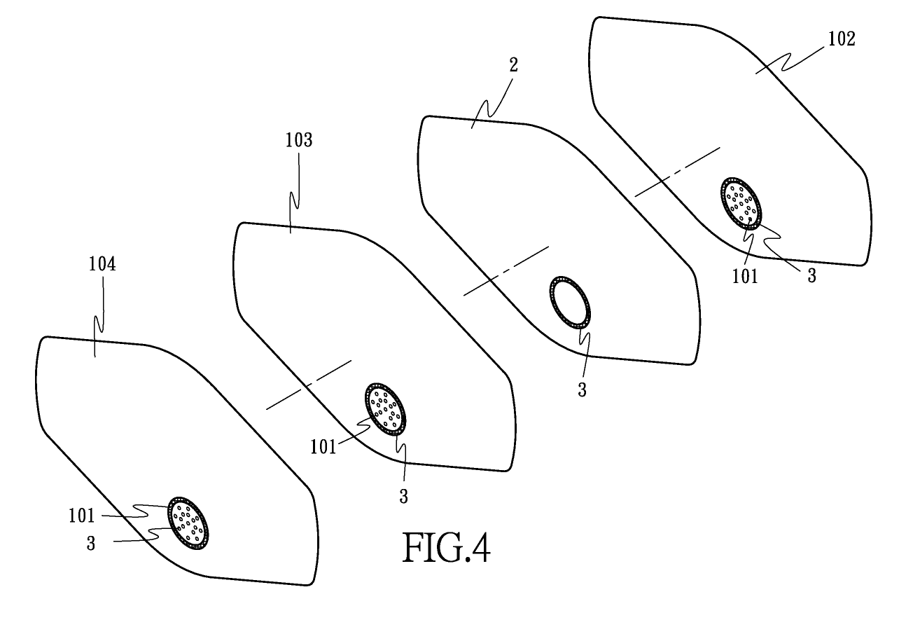

With reference to FIG. 4, The mask body of the surgical mask generally has a tree-layer structure. From outside to inside, a first layer of the surgical mask 102 is a waterproof layer that repels sprinkling water and spraying spittle; a second layer of the surgical mask 103 is a sterilization layer that has electrostatic filtering bacteria and a third layer of the surgical mask 104 is a water accepting layer that may absorb saliva. The sound film is disposed between the first layer 102 and the second layer 103 of the surgical mask or between the second layer 103 and the third layer 104 of the surgical mask and sealed to the mask body by ultrasonic wave. One or a plurality of holes 101 are provided at the sealing area and the sound-transmitting structure 2 for the transmission of the sound. The sound-transmitting structure 2 comprises the sound film, wherein the sound film, also known as the vibrating diaphragm, is made from ventilate materials and will vibrate with the air vibration caused by the sound, thereby transmitting the sound to the other side of the sound film. As the mask is provided with the sound-structure which comprises the sound film, when one speaks, the sound inside the mask may be completely transmitted to the mouthpiece of the phone, the microphone and the like outside the mask. The materials of the sound film are paper, tiffany, silk, aluminum, titanium, polyethylene terephthalate (PET), polyethylene naphthalene (PEN), polyetherimide (PEI), polyurethane (PU), polyaryletherketone (PEEK), thermoplastic polyurethanes (TPU), the high polymer material or other matters that may transmit the air vibration.

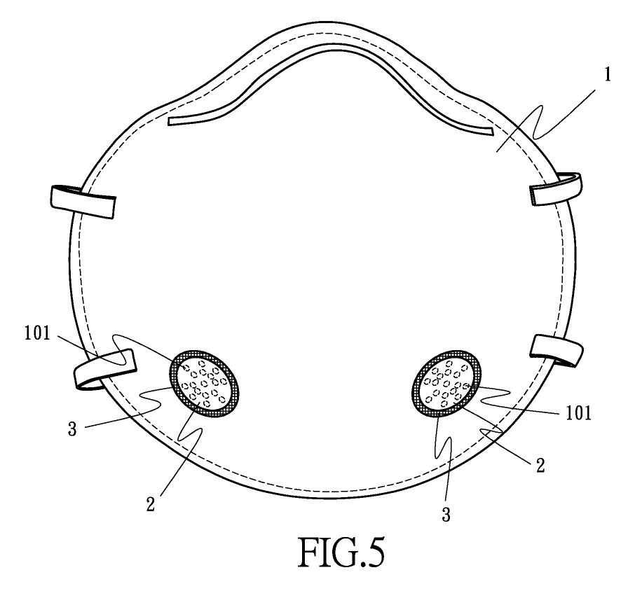

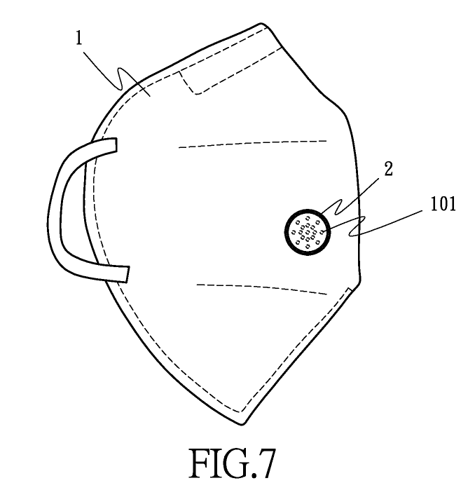

The mask may be provided with one or more (FIG. 5) sound-transmitting structures. The sound-transmitting structure may be located at the center of the mask. And because the mouthpiece of the cellphone may cling to the left or right side of the face, the sound-transmitting structure may also be selectively disposed at the left or right side of the mask (FIG. 7).

The above-mentioned detailed description aims to specifically illustrate the practicable embodiments of the present invention, but the embodiments are not for limiting the patent scope of the present invention and all equivalent embodiments or modifications made without departing from the spirit of the present invention shall be contained within the patent scope of the present invention.

The plentiful effects above-mentioned meet the lawful patent requirement for novelty and inventiveness. The inventor files an application according to law and earnestly urge honorable Office to approve the patent application of the present invention as an encouragement thereof.

1. A mask for enhancing sound transmission, comprising a mask body and a sound-transmitting structure, wherein the mask body comprises a porous stratified structure for enabling the inflow and outflow of air, wherein the sound-transmitting structure comprises a sound-transmitting hole and a sound film, wherein the sound inside the mask clearly transmits to the outside of the mask through the sound-transmitting structure.

2. The mask according to claim 1, wherein the mask body is a single-layer or multi-layer structure.

3. The mask according to claim 1, wherein the sound-transmitting structure may be disposed outside the mask body, inside the mask body or between the inner layer and the outer layer of the mask body.

4. The mask according to claim 1, wherein the number of the sound-transmitting structure is one or more,

5. The mask according to claim 1, wherein the sound-transmitting structure may be fixed on the mask body by sealing.

6. The mask according to claim 1, where the sound-transmitting structure may be stuck to the mask body by gum.

7. The mask according to claim 1, where the sound-transmitting structure may be clamped to the mask body by a bracket.

8. The mask according to claim 1, wherein the materials of the sound film comprise at least one of the following: paper, tiffany, silk, aluminum, titanium, polyethylene terephthalate (PET), polyethylene naphthalene (PEN), polyetherimide (PEI), polyurethane (PU), polyaryletherketone (PEEK), thermoplastic polyurethanes (TPU), and the high polymer material.

9. The mask according to claim 1, wherein the number of the sound-transmitting hole is one or more.

10. The mask according to claim 1, wherein the mask is selected from the group consisting of the lint face mask, the N95 mask, the surgical mask, the activated carbon mask, and the paper mask.
